(19) United States
(12) Patent Application Publication
(10) Pub. No.: US 2024/0104507 A1
(43) Pub. Date: Mar. 28, 2024

(54) TRUCKING SOFTWARE

(71) Applicant: Donterrel Evans, Lilburn, GA (US)

(72) Inventor: Donterrel Evans, Lilburn, GA (US)

(21) Appl. No.: 18/372,057

(22) Filed: Sep. 22, 2023

Related U.S. Application Data
(60) Provisional application No. 63/409,207, filed on Sep. 22, 2022.

(51) Int. Cl. G06Q 10/1053

(52) U.S. Cl. CPC G06Q 10/1053

(57) ABSTRACT

Implementations of a trucking software for a portable computing device, such as a smart phone, configured to use for connecting trucking companies with trucking related workers, such as drivers, mechanics, etc., and in some implementations, a corresponding software application for a computing device, such as a desktop or laptop computer.

### CROSS REFERENCE TO RELATED APPLICATION

This application claims the benefit of U.S. Patent Application Ser. No. 63/409,207, which was filed on Sep. 22 2022, and is incorporated herein by reference in its entirety.

### TECHNICAL FIELD

This disclosure relates to implementations of a trucking mobile and software application.

### BACKGROUND

The trucking industry involves various transactions between trucking companies, drivers, workers, and various other service providers. However, a mobile and software application does not exist that commodifies services (i.e., makes the services widely available and interchangeable) in the trucking industry.

### BRIEF DESCRIPTION OF THE DRAWINGS

FIG. 1 illustrates an implementation of an example environment of the trucking application according to the present disclosure.

FIG. 2 illustrates an example computer system, which may be used with implementations of the present disclosure.

FIGS. 3-24 illustrate implementations of example user interfaces of the trucking application according to the present disclosure.

### DETAILED DESCRIPTION

Implementations of a trucking software (“trucking application”) are provided. In some implementations, the trucking application comprises a mobile application for a portable computing device, such as a smart phone or similar device (e.g., an iPhone® or iPad®). In some implementations, the trucking application may comprise a corresponding software application for a computing device, such as a desktop or laptop computer. Therefore, the trucking application may be described or otherwise referred to collectively herein the present disclosure as an “application” or “software” for a “computing device”.

In some implementations, the trucking application is configured to connect trucking companies with trucking related workers, such as drivers, mechanics, etc.

In some implementations, the trucking application is configured to commodify services in the trucking industry by using the trucking application to aggregate transactions between trucking companies and workers/drivers. That is, in some implementations, the trucking application is configured to make the services widely available and interchangeable.

In some implementations, the trucking application is configured to allow trucking companies to post job opportunities that are then distributed to workers using the application.

In some implementations, the trucking application is configured to allow workers to create a profile containing the worker's availability, resume, driver's license, references, certificates, etc.

In some implementations, the trucking application is configured to allow trucking companies to search for workers by reviewing the worker profiles created using the application.

In some implementations, the trucking application is configured to allow workers to accept or indicate an interest in opportunities posted by trucking companies using the application.

In some implementations, the trucking application is further configured as described below with respect to the description of the user interfaces of the trucking application.

In some implementations, users of the trucking application may be any suitable users. For example, as introduced above, in some implementations, a user may be a driver or an owner-operator. In some implementations, a driver user may drive any suitable type of truck. In some implementations, an owner-operator user may own any suitable type of truck and/or be seeking opportunities for any suitable use of the trucks.

In some implementations, the product or service sought or offered by a user may be any suitable trucking related option, such as mechanics, tire services, parking or storage space (e.g., a user that has vacant land available that can be used for such space), lawyers/attorneys (e.g., of any suitable specialty, such as personal injury, intellectual property, employment, contracts, etc.), insurance agents, accountants (e.g., CPAs). tax consultants, bookkeepers, etc.

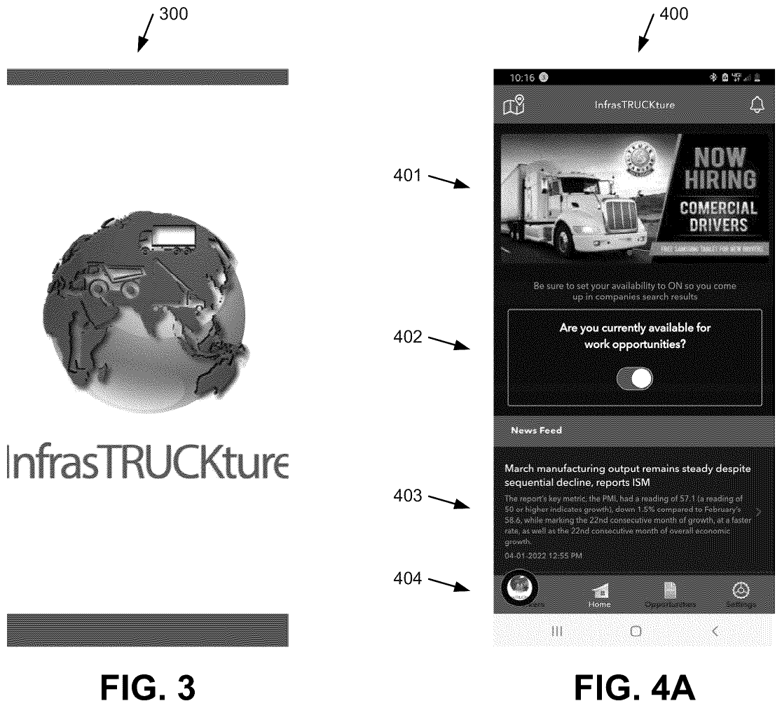

FIGS. 3-24 illustrate implementations of example user interfaces of the trucking application according to the present disclosure.

FIG. 3 illustrates an initial screen 300 (e.g., a splash screen) that the trucking application is configured to display on a computing device while the trucking application is opening or loading.

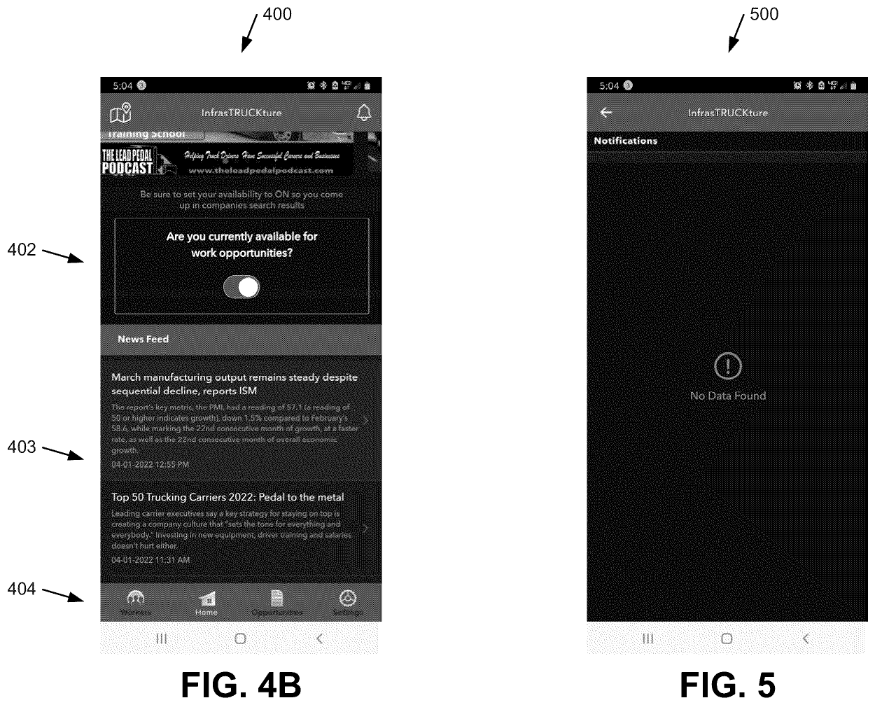

FIGS. 4A and 4B illustrate a home screen 400 that the trucking application is configured to display on a computing device. In some implementations, the trucking application is configured to display various advertisements of opportunities from trucking related partners in a first portion 401 of the home screen 400. In some implementations, the trucking application is configured to automatically scroll the advertisements and/or allow a user to manually scroll the advertisements using the computing device.

In some implementations, the trucking application is configured to display further information about an opportunity on the home screen 400 or another suitable screen when a user selects an advertisement using the computing device.

In some implementations, the trucking application is configured to display an on/off button regarding a user's availability in a second portion 402 of the home screen 400. In some implementations, the trucking application is configured to indicate (e.g., by displaying indicia to other users and/or in other screens) that the user is available for opportunities when the user selects the button to the on-condition using the computing device.

In some implementations, the trucking application is configured to enable additional features of the application when the button has been selected to the on-condition, such as to allow a user to search the available opportunities.

In some implementations, the trucking application is configured to display a newsfeed of trucking related information in a third portion 403 of the home screen 400. In some implementations, the trucking application is configured to automatically scroll the newsfeed and/or allow a user to manually scroll the newsfeed using the computing device.

In some implementations, the trucking application is configured to display navigation buttons or tabs for the application in a fourth portion 404 of the home screen 400. In some implementations, the trucking application is configured to display or hide one or more of the buttons based on the type of user logged-in to the application.

For example, in some implementations, the trucking application is configured to display all four of the buttons for a user who is a trucking owner-operator (e.g., a user who both owns and operates/drives trucks). In some implementations, the trucking application is configured to hide the ‘Workers’ button and display the other three buttons for a user who is a driver.

In some implementations, the ‘Workers’ button allows a user (such as an owner-operator) to navigate to one or more screens to search for additional workers (such as drivers). For example, in some implementations, selecting the ‘Workers’ button will cause the application to display a list of available drivers who have registered using the application.

In some implementations, the trucking application is configured to display available opportunities that a user qualifies to consider in response to a user selecting the ‘Opportunities’ button using the computing device. For example, in some implementations, the trucking application may be configured to display opportunities for an owner-operator user to use his trucks.

In some implementations, the trucking application is configured to display various available settings for the application when a user selects the ‘Settings’ button using the computing device.

These and other features of the trucking application are further described below with respect to other user interfaces/screens.

FIG. 5 illustrates a notifications screen 500 that the trucking application is configured to display on a computing device. In some implementations, the trucking application is configured to display a list of and allow a user to select from various notifications related to the features and options of the trucking application for viewing in the notifications screen 500.

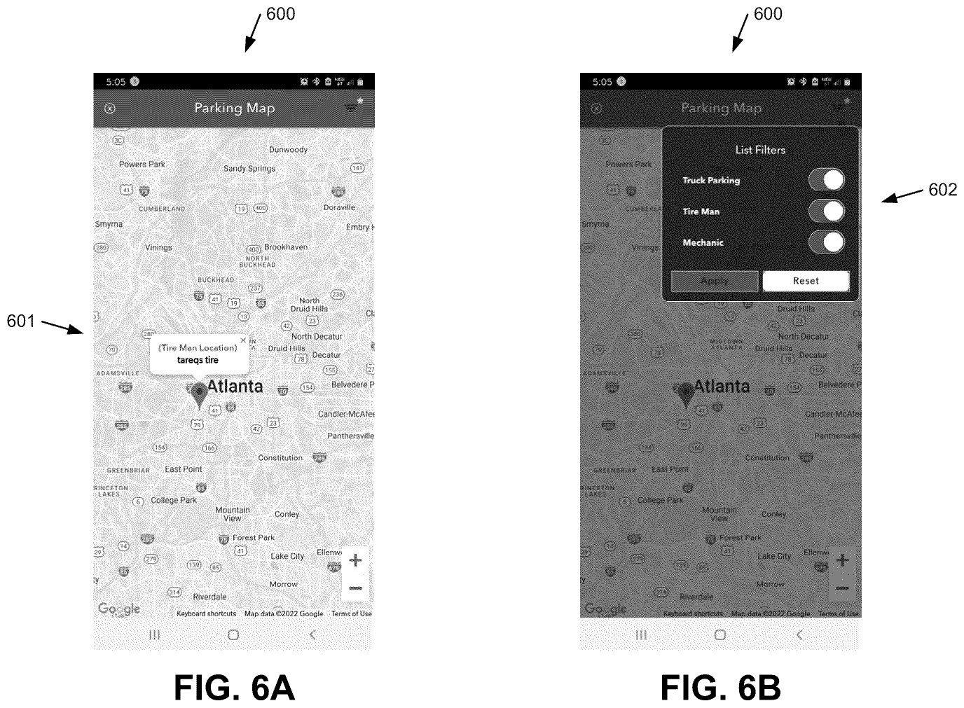

FIG. 6A illustrates a map screen 600 that the trucking application is configured to display on a computing device. In some implementations, the trucking application is configured to display indicators 601 for available users in the area displayed on the map screen 600. As described further below, in some implementations, the trucking application is configured to display information related to a user when an indicator 601 is selected from the map screen 600 using the computing device.

In some implementations, the map screen 600 is interactive. For example, in some implementations, the map screen 600 can be panned, zoomed, etc.

FIG. 6B illustrates the map screen 600 with a drop-down filter menu 602 that the trucking application is configured to display on a computing device. In some implementations, the filter menu 602 allows a user to select to filter the available users displayed by skills, products, services, etc. provided or needed by the available users.

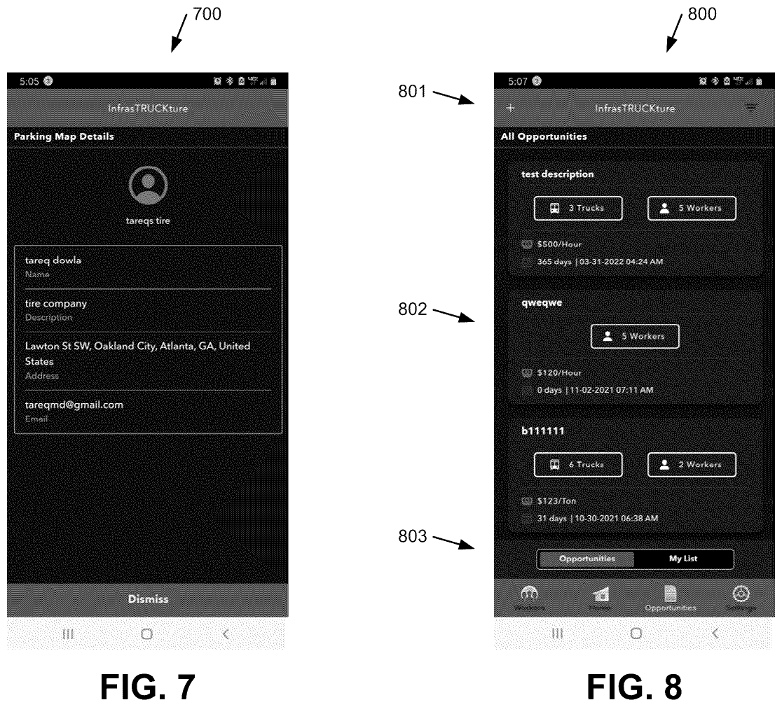

FIG. 7 illustrates a user details screen 700 that the trucking application is configured to display on a computing device. In some implementations, the user details screen 700 shows information and details about a driver/user selected from the map screen 600 by a user using the computing device.

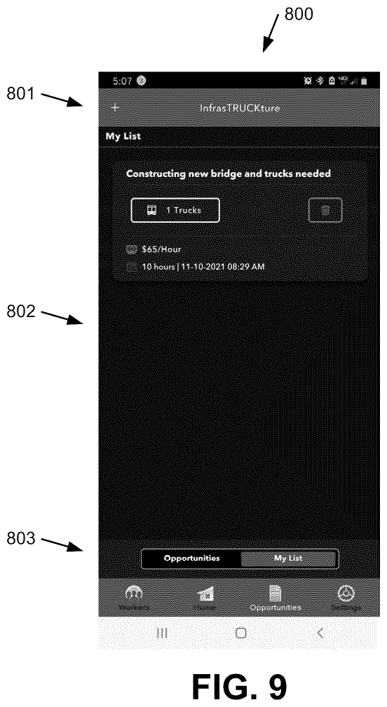

FIGS. 8 and 9 illustrate an opportunity list screen 800 that the trucking application is configured to display on a computing device. In some implementations, the trucking application is configured to allow a user to use the opportunity list screen 800 to take/do an opportunity or to add an opportunity for others to take/do using the computing device.

In some implementations, the opportunity screen 800 comprises a first portion 801 that includes buttons for adding an opportunity and filtering the listed opportunities.

In some implementations, the opportunity screen 800 comprises a second portion 802 that lists some details for each opportunity (or shift) listed, such as what is needed (e.g., trucks, workers, etc.), the start date/time of the opportunity, and the duration of the opportunity.

In some implementations, the opportunity screen 800 comprises a third portion 803 that includes buttons for selecting to show the full list of opportunities (which is shown in FIG. 8) or just the user selected list (‘MyList’) of opportunities (which is shown in FIG. 9). In some implementations, the ‘MyList’ of opportunities are those that have been applied for or confirmed or that have been added as available by the user.

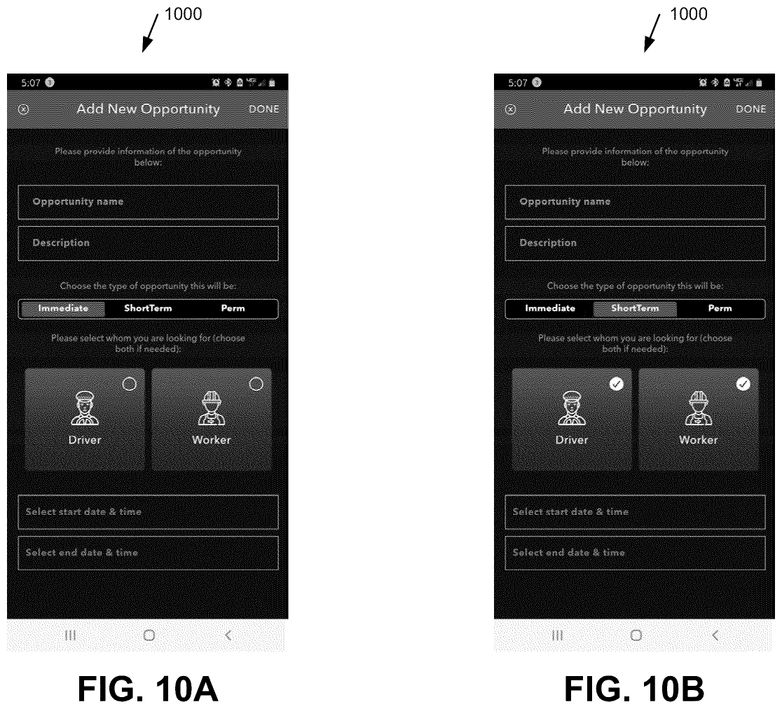

FIGS. 10A and 10B illustrate an add opportunity screen 1000 that the trucking application is configured to display on a computing device. In some implementations, the trucking application is configured to display the screen 1000 when a user selects the add an opportunity button from the opportunity list screen 800 using the computing device.

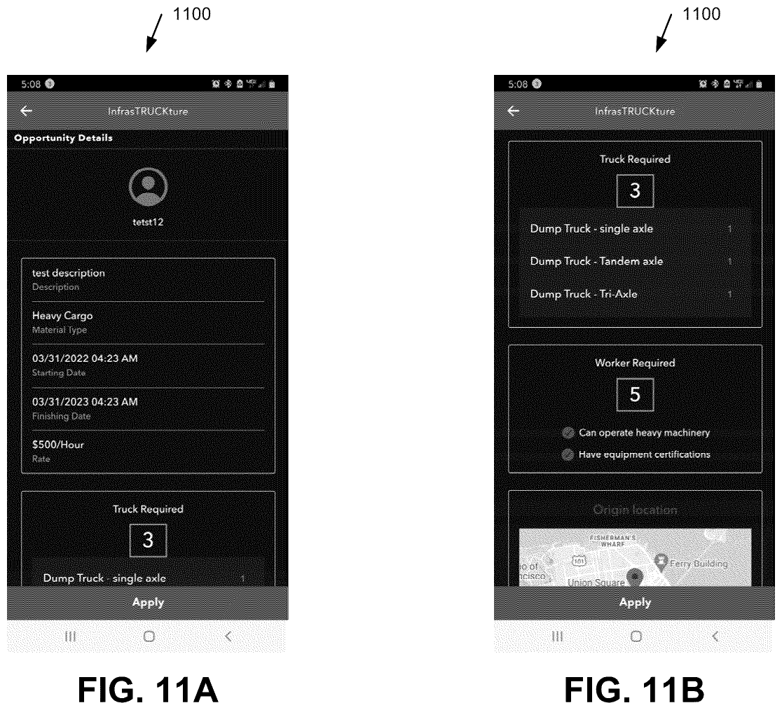

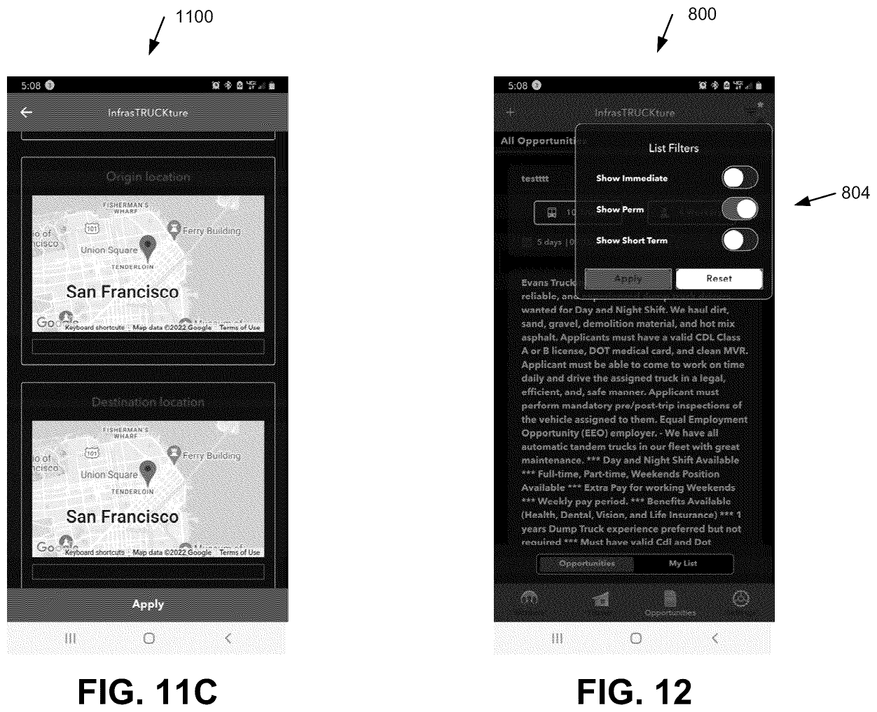

FIGS. 11A-11C illustrate an opportunity details screen 1100 that the trucking application is configured to display on a computing device. In some implementations, the details screen 1100 shows all pertinent details, such as what is needed (e.g., trucks, workers, etc.), of an opportunity a user selects to review from the opportunity list screen 800 using the computing device.

In some implementations, the details screen 1100 also shows location information, such as origin and destination of an opportunity, on a map.

In some implementations, the details screen 1100 also includes an apply button for a user to select using the computing device to apply for the opportunity that is detailed on the screen 1100.

FIG. 12 illustrates the opportunity list screen 800 with a drop-down filter menu 804 that the trucking application is configured to display on a computing device. In some implementations, the filter menu 804 allows a user to select to filter the available opportunities displayed based e.g. on the duration type (e.g., immediate, permanent, or short term).

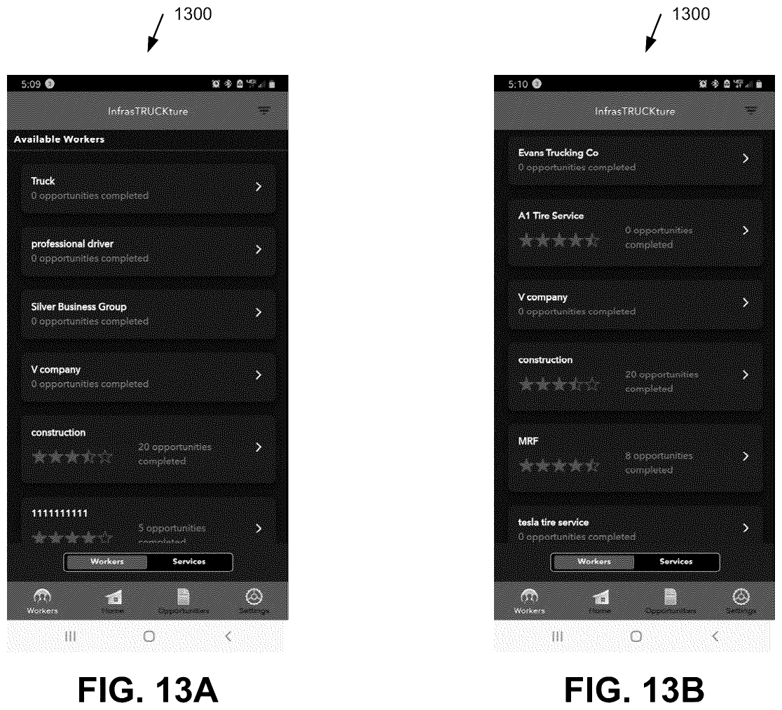

FIGS. 13A and 13B illustrate an available workers list screen 1300 that the trucking application is configured to display on a computing device. In some implementations, the trucking application is configured to display the screen 1300 when a user selects the ‘Workers’ button from other screens such as the home screen 400 using the computing device.

In some implementations, the available workers list screen 1300 shows users who have selected the button regarding a user's availability (i.e., from the home screen 400) to the on-condition using the computing device. In some implementations, the available workers list screen 1300 shows the users' information of what they offer.

In some implementations, the users listed on the available workers list screen 1300 are transportation based, such as drivers, owner-operators, or construction workers.

In some implementations, the available workers list screen 1300 also shows info about the listed users such as the number of previously completed opportunities and the user's rating (if available).

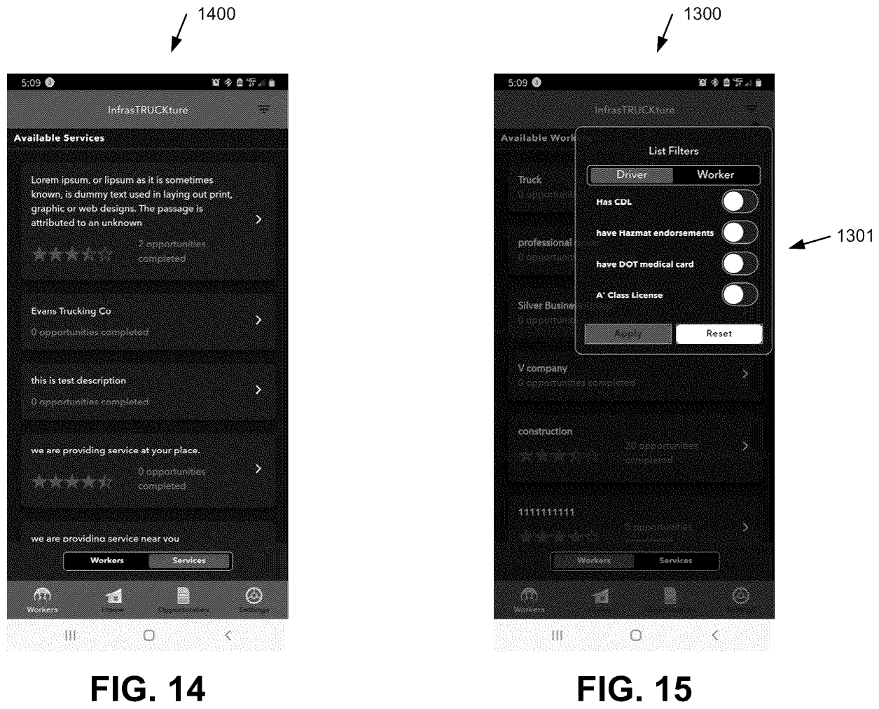

FIG. 14 illustrates an available services list screen 1400 that the trucking application is configured to display on a computing device. In some implementations, the trucking application is configured to display the screen 1400 when a user selects the ‘Workers’ button from other screens such as the home screen 400 and then selects the ‘Services’ option button at the bottom of the available workers list screen 1300 using the computing device.

In some implementations, the available services list screen 1400 shows users who have selected the button regarding a user's availability (i.e., from the home screen 400) to the on-condition using the computing device. In some implementations, the available services list screen 1400 shows the users' information of what they offer.

In some implementations, the users listed on the available services list screen 1400 are transportation based services, such as tire-men, mechanics, parking-lodging, lawyers, accountants, etc. (i.e., services that support the transportation based workers).

In some implementations, the available services list screen 1400 also shows info about the listed users such as the number of previously completed opportunities and the user's rating (if available).

FIG. 15 illustrates the available workers list screen 1300 with a drop-down filter menu 1301 that the trucking application is configured to display on a computing device. In some implementations, the filter menu 1301 allows a user to select to filter the available workers displayed based e.g. on driver/worker status, licensing, and/or certifications.

In some implementations, a similar filter menu option is available for the available services list screen 1400.

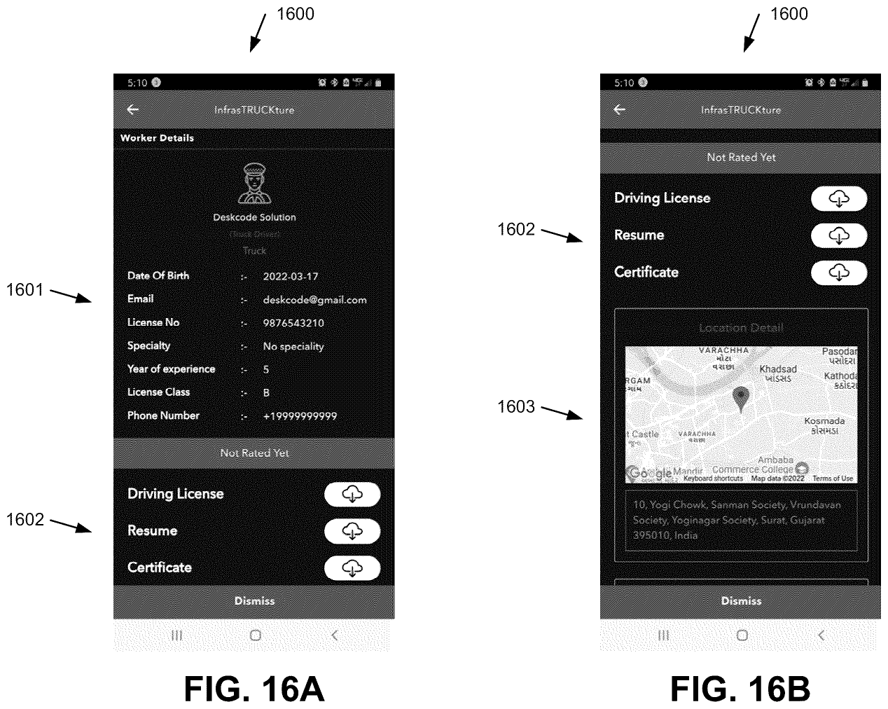

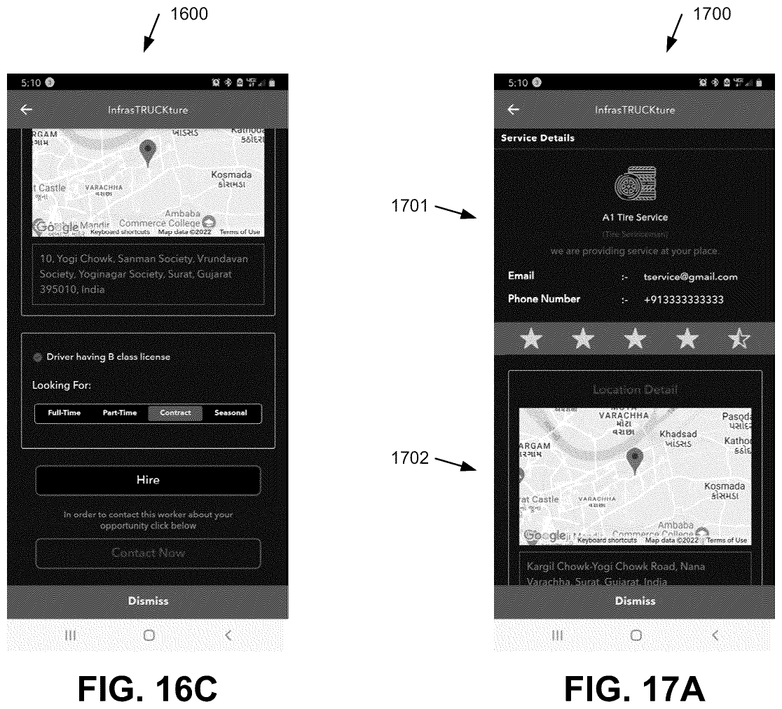

FIGS. 16A-16C illustrate an available worker details screen 1600 that the trucking application is configured to display on a computing device. In some implementations, the available worker details screen 1600 shows the details of a worker selected from the available workers list screen 1300.

In some implementations, a first portion 1601 of the screen 1600 shows the worker information. In some implementations, a second portion 1602 of the screen 1600 includes download buttons for a user to select using the computing device to view or otherwise retrieve documents for review, verification, etc (e.g., before hiring) that the worker uploaded, such as a drivers license, resume, related certificates (e.g., compliance related), etc.

In some implementations, a third portion 1603 of the screen 1600 shows location information of the worker, including on a map.

In some implementations, the available worker details screen 1600 also includes buttons at the bottom of the screen 1600 that allow a user to select to hire or contact the worker using the computing device.

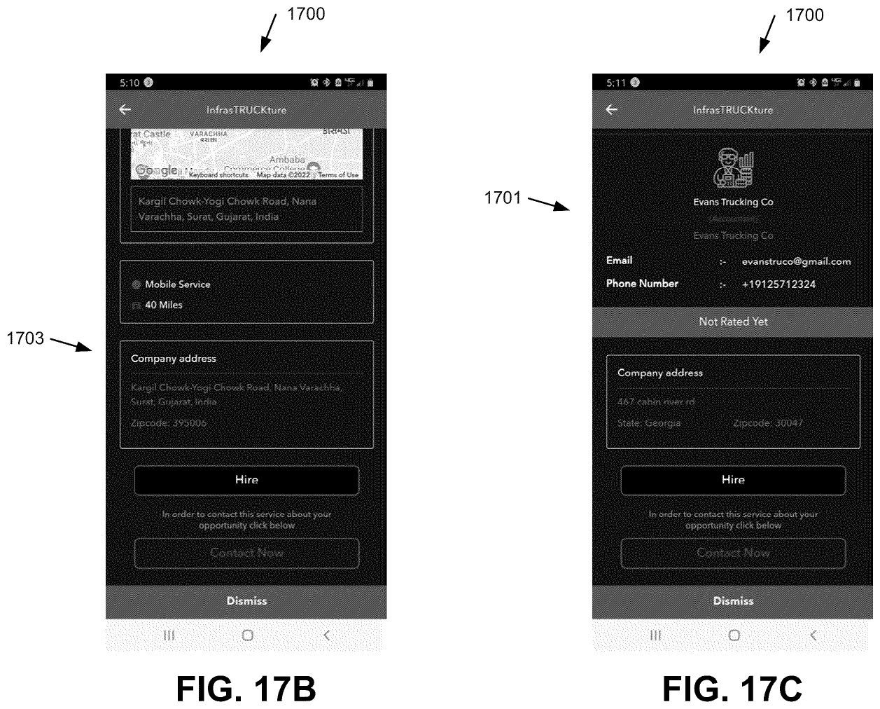

FIGS. 17A-17C illustrate an available services details screen 1700 that the trucking application is configured to display on a computing device. In some implementations, the available services details screen 1700 shows the details of a service provider selected from the available services list screen 1400 by a user using the computing device.

In some implementations, a first portion 1701 of the screen 1700 shows the service provider information. In some implementations, a second portion 1702 of the screen 1700 shows location information of the service provider, including on a map.

In some implementations, a third portion 1703 of the screen 1700 shows additional information about the service provider.

In some implementations, the available services details screen 1700 also includes buttons at the bottom of the screen 1700 that allow a user to select to hire or contact the service provider using the computer device.

FIG. 18 illustrates a settings menu screen 1800 that the trucking application is configured to display on a computing device. In some implementations, the settings menu screen 1800 comprises buttons or tabs that allow a user to select various settings or other features of the trucking application using the computing device, such as described below.

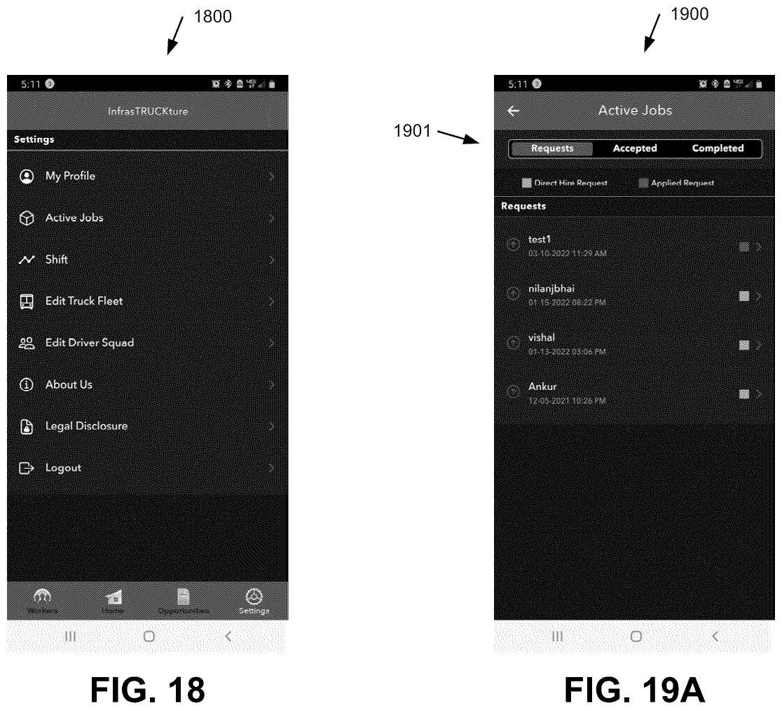

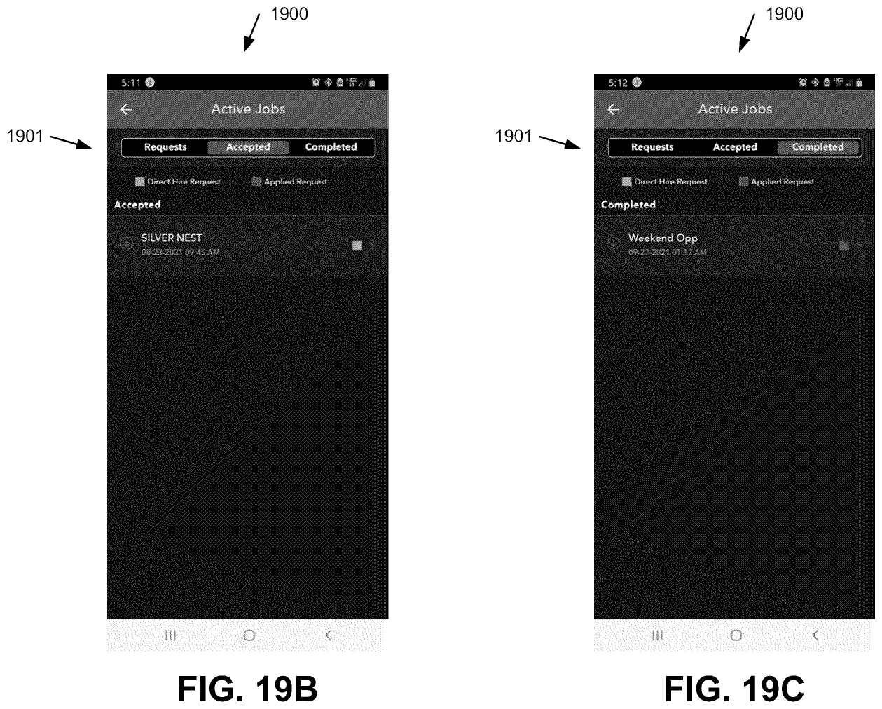

FIGS. 19A-19C illustrate an active jobs screen 1900 that the trucking application is configured to display on a computing device. In some implementations, the trucking application is configured to display the screen 1900 when a user selects the active jobs button from the settings menu screen 1800 using the computing device.

As shown in FIGS. 19A-19C respectively, in some implementations, the active jobs screen 1900 lists requested, accepted, or completed jobs based on a user's selection of the corresponding button or tab from a first portion 1901 of the screen 1900 using the computing device.

In some implementations, as indicated by an icon of a first color (e.g., orange) or a second color (e.g., red) displayed by the trucking application, the active jobs screen 1900 lists direct hire requests and applied requests respectively.

In some implementations, the direct hire requests are requests received from other users in response to the current user's posted opportunities. In some implementations, the applied requests are requests submitted for opportunities posted by other users.

In some implementations, the listed active jobs can be selected by a user from the screen 1900 using the computing device to view additional details about a job.

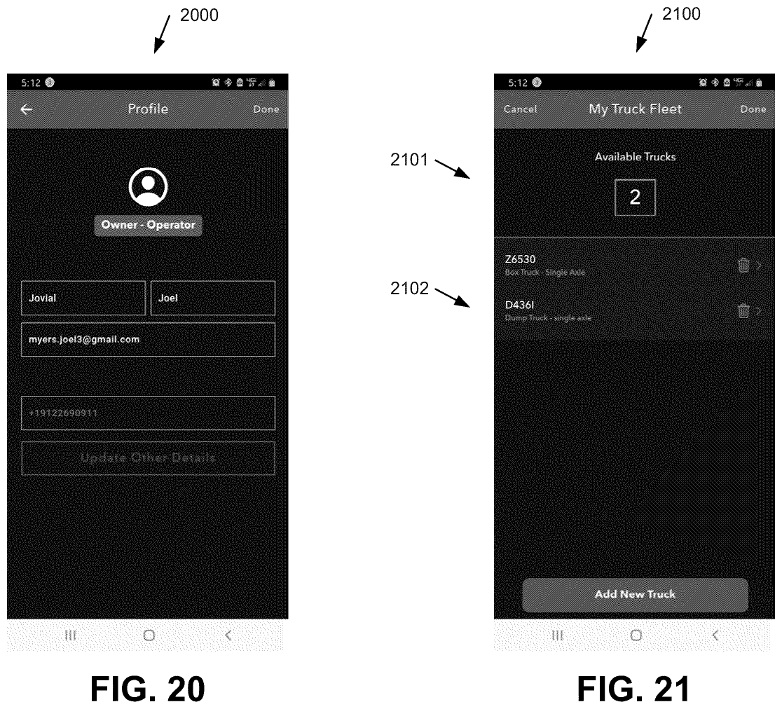

FIG. 20 illustrates a user profile information screen 2000 that the trucking application is configured to display on a computing device. In some implementations, the trucking application is configured to display the screen 2000 when a user selects the user profile (e.g., ‘My Profile’) button from the settings menu screen 1800 using the computing device.

FIG. 21 illustrates an edit truck fleet information screen 2100 that the trucking application is configured to display on a computing device. In some implementations, the trucking application is configured to display the screen 2100 when a user selects the corresponding button from the settings menu screen 1800 using the computing device.

In some implementations, the edit truck fleet screen 2100 comprises a first portion 2101 that includes an indicator of how many trucks are available in the fleet.

In some implementations, the edit truck fleet screen 2100 comprises a second portion 2102 that lists the user's (e.g., an owner-operator's) truck fleet. In some implementations, the listing allows a user to select to view, edit, or delete each listing for the truck fleet using the computing device.

In some implementations, the edit truck fleet screen 2100 also includes a button at the bottom of the screen 2100 that allows a user to select to add information for a new/additional truck to the listing using the computing device.

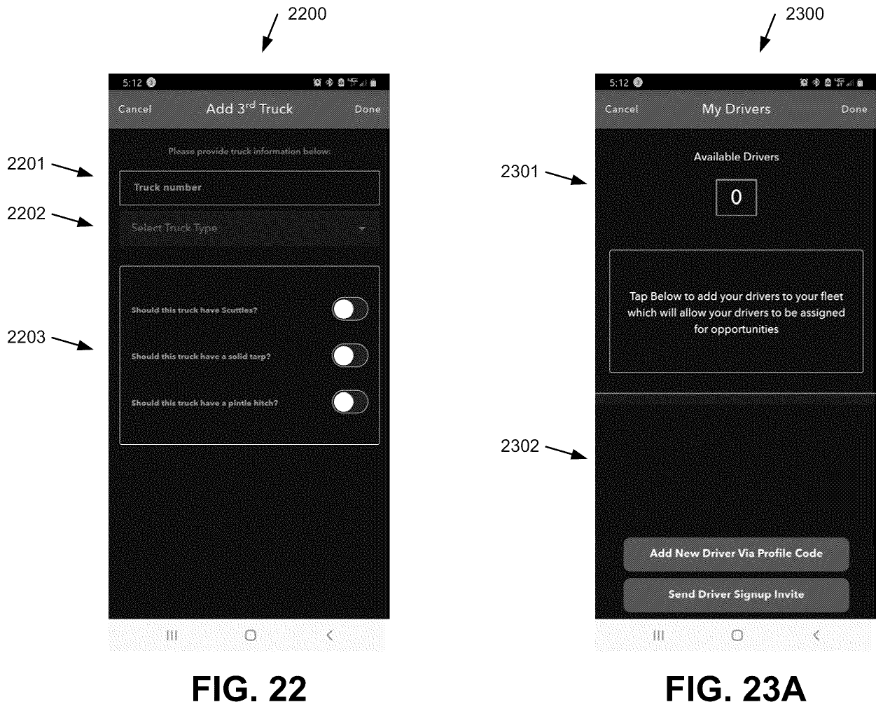

FIG. 22 illustrates an add truck screen 2200 that the trucking application is configured to display on a computing device. In some implementations, the trucking application is configured to display the screen 2200 when a user selects the add new truck button from the edit truck fleet screen 2100 using the computing device.

In some implementations, the add truck screen 2200 comprises various text input fields 2201, menu selection options 2202, and button set options 2203 that allow a user to enter information for adding a new truck to the fleet list 2100 using the computing device.

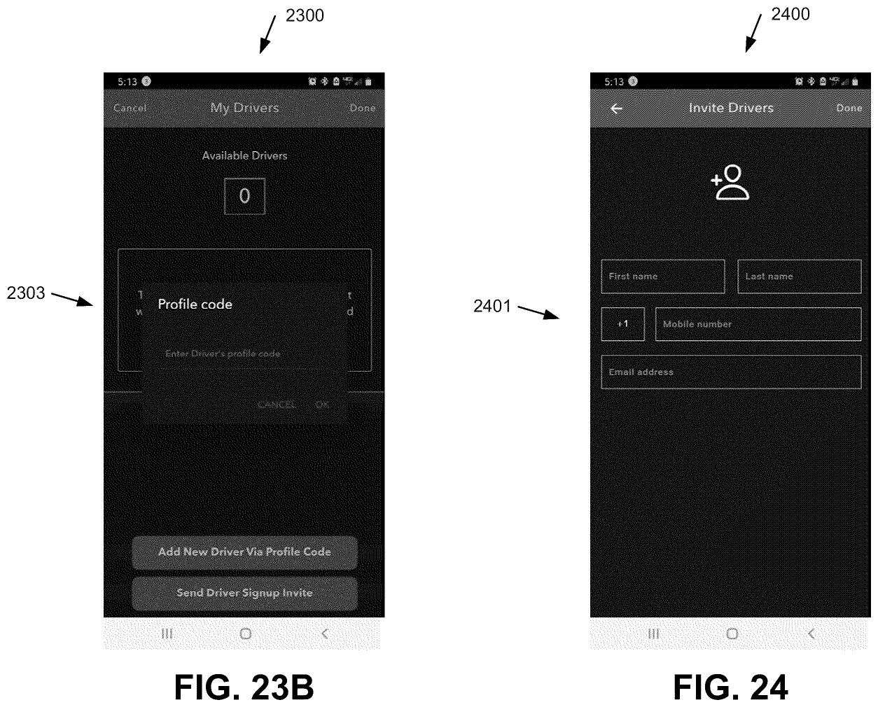

FIG. 23A illustrates an edit driver squad information screen 2300 that the trucking application is configured to display on a computing device. In some implementations, the trucking application is configured to display the screen 2300 when a user selects the edit driver squad button from the settings menu screen 1800 using the computing device.

In some implementations, the edit driver squad screen 2300 comprises a first portion 2301 that includes an indicator of how many drivers are available in the squad.

In some implementations, the edit driver squad screen 2300 comprises a second portion 2302 that lists the user's (e.g., an owner-operator's) driver squad. In some implementations, the listing allows for selection to view, edit, or delete each listing for the driver squad using the computing device.

In some implementations, the edit driver squad screen 2300 also includes buttons at the bottom of the screen 2300 that allow a user to select to add information for a new/additional driver to the listing and to select to send a driver signup invitation using the computing device.

FIG. 23B illustrates an add driver pop-up window 2303 on the edit driver squad screen 2300 that the trucking application is configured to display on a computing device. In some implementations, the add driver pop-up window 2303 is opened by selecting the add new driver button from the edit driver squad screen 2300 using the computing device.

In some implementations, the add driver pop-up window 2303 allows a user to add a driver by entering a driver profile code in the window 2303 using the computing device. Alternately and/or additionally, the driver may be added by the user manually entering the driver information using the computing device, e.g. similar to for entering the truck information on the add truck screen 2200.

FIG. 24 illustrates a driver signup invite screen 2400 that the trucking application is configured to display on a computing device. In some implementations, the trucking application is configured to display the screen 2400 when a user selects the send driver signup invite button from the edit driver squad screen 2300 using the computing device.

In some implementations, the driver signup invite screen 2400 comprises various fields 2401 that allow a user to enter the driver contact information for the invite using the computing device, such as the driver's name, phone number, and email address.

In some implementations, the invite is sent by the trucking application to invite a new user/driver to create a user profile in the application and then participate in the application features, such as those described herein, and also to allow the invited driver's profile, location, etc to be viewed by other users for the features of the application using a computing device.

In some implementations, through the above described screens 400, 500, 600, 700, 800, 1000, 1100, 1300, 1400, 1600, 1700, 1800, 1900, 2000, 2100, 2200, 2300, 2400, the trucking application is configured to connect trucking companies with trucking related workers, such as drivers, mechanics, etc.

In some implementations, through the above described screens 400, 600, 700, 800, 1000, 1100, 1300, 1400, 1600, 1700, 1800, 1900, 2000, 2100, 2200, 2300, 2400, the trucking application is configured to commodify services in the trucking industry by using the trucking application to aggregate transactions between trucking companies and workers/drivers.

In some implementations, through the above described screens 400, 500, 600, 700, 800, 1000, 1100, 1300, 1400, 1600, 1700, 1800, 1900, 2000, 2100, 2200, 2300, 2400, the trucking application is configured to allow trucking companies to post job opportunities that are then distributed to workers using the application.

In some implementations, through the above described screens 1800, 2000, the trucking application is configured to allow workers to create a profile containing the worker's availability, resume, driver's license, references, certificates, etc.

In some implementations, through the above described screens 600, 700, 800, 1000, 1100, 1300, 1400, 1600, 1700, 1800, 1900, 2000, 2100, 2200, 2300, 2400, the trucking application is configured to allow trucking companies to search for workers by reviewing the worker profiles created using the application.

In some implementations, through the above described screens 600, 700, 800, 1000, 1100, 1300, 1400, 1600, 1700, 1800, 1900, 2000, 2100, 2200, 2300, 2400, the trucking application is configured to allow workers to accept or indicate an interest in opportunities posted by trucking companies using the application.

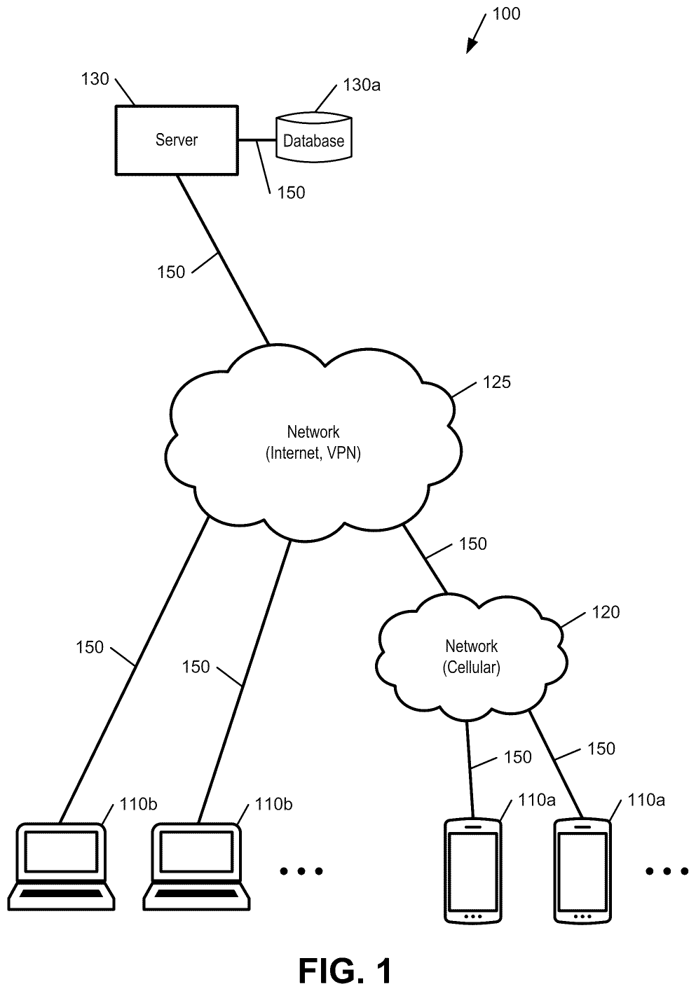

FIG. 1 illustrates an implementation of an example environment 100 of a trucking application according to the present disclosure.

As shown in FIG. 1, in some implementations, the environment 100 may include one or more client devices 110a and 110b (collectively “client devices 110”), wireless cellular network 120, network 125, and servers 130. In some implementations, the environment 100 may also include one or more data storages 130a linked to the servers 130.

As described above, in some implementations, a computing device (“client device”) 110 may be used to connect trucking companies with trucking related workers, such as drivers, mechanics, etc using the trucking application. In some implementations, the client device 110 may be used to open, login, and manage the use of the trucking application.

As described above, in some implementations, the client device 110 may be used to commodify services in the trucking industry by using the trucking application to aggregate transactions between trucking companies and workers/drivers by making the services widely available and interchangeable.

As described above, in some implementations, the client device 110 may be used to allow trucking companies to post job opportunities that are then distributed to workers using the trucking application.

As described above, in some implementations, the client device 110 may be used to allow workers to create a profile containing the worker's availability, resume, driver's license, references, certificates, etc.

As described above, in some implementations, the client device 110 may be used to allow trucking companies to search for workers by reviewing the worker profiles created using the trucking application.

As described above, in some implementations, the client device 110 may be used to allow workers to accept or indicate an interest in opportunities posted by trucking companies using the trucking application.

Client devices 110a and 110b (collectively “client devices 110”) are depicted as a mobile phone 110a and a desktop computer 110b, respectively, but client devices 110 may comprise any type of computing device, such as a desktop computer system, a laptop, cellular phone, a smart device, a mobile telephone, a tablet-style computer, or any other device capable of wireless or wired communication. In some implementations, client devices 110 are configured to interact with the server 130 via an application, such as a web browser or a native application, residing on the client device 110.

In some implementations, the client devices 110 include hardware, software, or embedded logic components or a combination of two or more such components and is configured to carry out the appropriate functions implemented or supported by the client devices 110.

In some implementations, the client devices 110 may include one or more processors, one or more memories, one or more displays, one or more interfaces, one or more components capable of inputting data, one or more components capable of outputting data, one or more components capable of communicating with any other component of the environment 100 or any other component suitable for a particular purpose.

In some implementations, the client devices 110 are configured to access networks 120 and/or 125. In some implementations, the client devices 110 are configured to communicate with servers 130.

In some implementations, the client devices 110 can connect to the network 125 through a wireless cellular network 120, such as GPRS-based and CDMA-based wireless networks, as well as 802.16 WiMax and long-range wireless data networks.

In some implementations, components of the environment 100 may communicate with any other component of the environment 100 over network 125. Network 125 may be any suitable network. In some implementations, for example, one or more portions of network 125 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, another network 125, or a combination of two or more of the foregoing.

In some embodiments, components of the environment 100 may be configured to communicate over links 150. Links 150 may connect components of the environment 100 to networks 120, 125 or to each other. In some implementations, one or more links 150 may include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 150 may each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links 150. Links 150 may not be the same throughout the environment 100.

In some implementations, the server devices 130 may include a processor, memory, user accounts, and one or more modules to perform various functions such as those described above.

In some implementations, each server 130 may be a unitary server or may be a distributed server spanning multiple computers or multiple datacenters. Servers 130 may be of various types, such as, for example and without limitation, web server, file server, application server, exchange server, database server, or proxy server. In some implementations, each server 130 may include hardware, software, or embedded logic components or a combination of two or more such components for carrying out the appropriate functionalities implemented or supported by server 130. For example, a web server is generally capable of hosting websites containing web pages or particular elements of web pages. More specifically, a web server may host HTML files or other file types, or may dynamically create or constitute files upon a request, and communicate them to clients 110 in response to HTTP or other requests from clients 110. A database server is generally capable of providing an interface for managing data stored in one or more data stores.

In some implementations, one or more data storages 130a may be communicatively linked to one or more servers 130, respectively, via one or more links 150. In some implementations, data storages 130a may be used to store various types of information. In some implementations, the information stored in data storages 130a may be organized according to specific data structures. In particular embodiment, each data storage 130a may be a relational database. Particular embodiments may provide interfaces that enable servers 130 or clients 110 to manage, e.g., retrieve, modify, add, or delete, the information stored in data storage 130a.

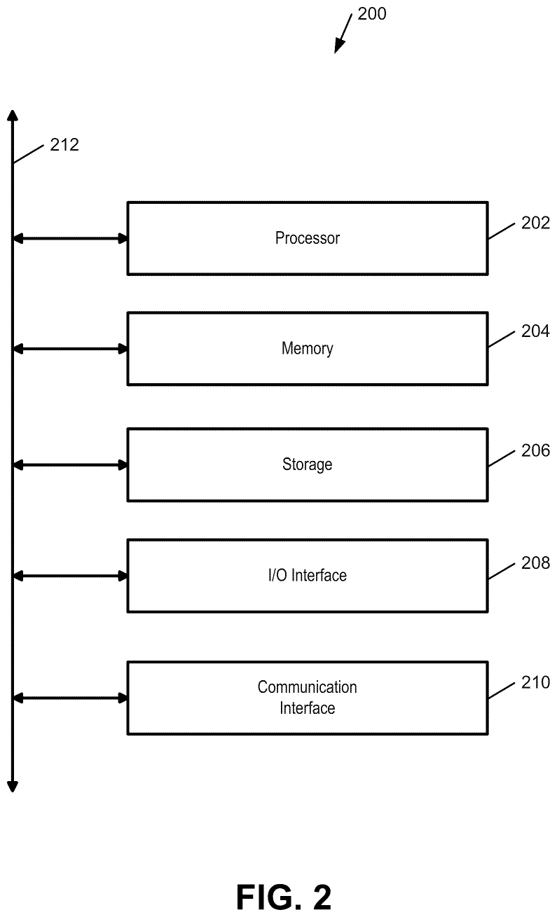

FIG. 2 illustrates an example computer system 200, which may be used with some implementations of the present invention. This disclosure contemplates any suitable number of computer systems 200.

This disclosure contemplates computer system 200 taking any suitable physical form. In some implementations, as an example and not by way of limitation, computer system 200 may be an embedded computer system, a system-on-chip (SOC), a single-board computer system (SBC) (such as, for example, a computer-on-module (COM) or system-on-module (SOM)), a desktop computer system, a laptop, an interactive kiosk, a mainframe, a mesh of computer systems, a mobile telephone, a personal digital assistant (PDA), a server, or a combination of two or more of these.

In some implementations, where appropriate, computer system 200 may include one or more computer systems 200; be unitary or distributed; span multiple locations; span multiple machines; or reside in a cloud, which may include one or more cloud components in one or more networks.

In some implementations, where appropriate, one or more computer systems 200 may perform without substantial spatial or temporal limitation one or more steps of one or more methods described or illustrated herein. In some implementations, as an example and not by way of limitation, one or more computer systems 200 may perform in real time or in batch mode one or more steps of one or more methods described or illustrated herein. In some implementations, one or more computer systems 200 may perform at different times or at different locations one or more steps of one or more methods described or illustrated herein, where appropriate.

In some implementations, computer system 200 includes a processor 202, memory 204, storage 206, an input/output (I/O) interface 208, a communication interface 210, and a bus 212. Although this disclosure describes and illustrates a particular computer system having a particular number of particular components in a particular arrangement, this disclosure contemplates any suitable computer system having any suitable number of any suitable components in any suitable arrangement.

In some implementations, processor 202 includes hardware for executing instructions, such as those making up a computer program. In some implementations, as an example and not by way of limitation, to execute instructions, processor 202 may retrieve (or fetch) the instructions from an internal register, an internal cache, memory 204, or storage 206; decode and execute them; and then write one or more results to an internal register, an internal cache, memory 204, or storage 206.

In some implementations, processor 202 may include one or more internal caches for data, instructions, or addresses. The present disclosure contemplates processor 202 including any suitable number of any suitable internal caches, where appropriate. In some implementations, as an example and not by way of limitation, processor 202 may include one or more instruction caches, one or more data caches, and one or more translation look-aside buffers (TLBs).

In some implementations, instructions in the instruction caches may be copies of instructions in memory 204 or storage 206, and the instruction caches may speed up retrieval of those instructions by processor 202.

In some implementations, data in the data caches may be copies of data in memory 204 or storage 206 for instructions executing at processor 202 to operate on; the results of previous instructions executed at processor 202 for access by subsequent instructions executing at processor 202 or for writing to memory 204 or storage 206; or other suitable data.

In some implementations, the data caches may speed up read or write operations by processor 202. In some implementations, the TLBs may speed up virtual-address translation for processor 202.

In some implementations, processor 202 may include one or more internal registers for data, instructions, or addresses. The present disclosure contemplates processor 202 including any suitable number of any suitable internal registers, where appropriate. Where appropriate, processor 202 may include one or more arithmetic logic units (ALUs); be a multi-core processor; or include one or more processors 202. Although this disclosure describes and illustrates a particular processor, this disclosure contemplates any suitable processor.

In some implementations, memory 204 includes main memory for storing instructions for processor 202 to execute or data for processor 202 to operate on. In some implementations, as an example and not by way of limitation, computer system 200 may load instructions from storage 206 or another source (such as, for example, another computer system 200) to memory 204.

In some implementations, processor 202 may then load the instructions from memory 204 to an internal register or internal cache. In some implementations, to execute the instructions, processor 202 may retrieve the instructions from the internal register or internal cache and decode them.

In some implementations, during or after execution of the instructions, processor 202 may write one or more results (which may be intermediate or final results) to the internal register or internal cache. In some implementations, processor 202 may then write one or more of those results to memory 204.

In some implementations, processor 202 executes only instructions in one or more internal registers or internal caches or in memory 204 (as opposed to storage 206 or elsewhere) and operates only on data in one or more internal registers or internal caches or in memory 204 (as opposed to storage 206 or elsewhere).

In some implementations, one or more memory buses (which may each include an address bus and a data bus) may couple processor 202 to memory 204. In some implementations, bus 212 may include one or more memory buses, as described below.

In some implementations, one or more memory management units (MMUs) reside between processor 202 and memory 204 and facilitate accesses to memory 204 requested by processor 202.

In some implementations, memory 204 includes random access memory (RAM). In some implementations, this RAM may be volatile memory, where appropriate.

In some implementations, where appropriate, this RAM may be dynamic RAM (DRAM) or static RAM (SRAM). Moreover, in some implementations, where appropriate, this RAM may be single-ported or multi-ported RAM. The present disclosure contemplates any suitable RAM.

In some implementations, memory 204 may include one or more memories 204, where appropriate. Although this disclosure describes and illustrates particular memory, this disclosure contemplates any suitable memory.

In some implementations, storage 206 includes mass storage for data or instructions. In some implementations, as an example and not by way of limitation, storage 206 may include an HDD, a floppy disk drive, flash memory, an optical disc, a magneto-optical disc, magnetic tape, or a Universal Serial Bus (USB) drive or a combination of two or more of these.

In some implementations, storage 206 may include removable or non-removable (or fixed) media, where appropriate. In some implementations, storage 206 may be internal or external to computer system 200, where appropriate. In some implementations, storage 206 is non-volatile, solid-state memory.

In some implementations, storage 206 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 206 taking any suitable physical form.

In some implementations, storage 206 may include one or more storage control units facilitating communication between processor 202 and storage 206, where appropriate. In some implementations, where appropriate, storage 206 may include one or more storages 206. Although this disclosure describes and illustrates particular storage, this disclosure contemplates any suitable storage.

In some implementations, I/O interface 208 includes hardware, software, or both providing one or more interfaces for communication between computer system 200 and one or more I/O devices. In some implementations, computer system 200 may include one or more of these I/O devices, where appropriate.

In some implementations, one or more of these I/O devices may enable communication between a person and computer system 200. In some implementations, as an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these.

In some implementations, an I/O device may include one or more sensors. This disclosure contemplates any suitable I/O devices and any suitable I/O interfaces 208 for them.

In some implementations, where appropriate, I/O interface 208 may include one or more device or software drivers enabling processor 202 to drive one or more of these I/O devices. I/O interface 208 may include one or more I/O interfaces 208, where appropriate. Although this disclosure describes and illustrates a particular I/O interface, this disclosure contemplates any suitable I/O interface.

In some implementations, communication interface 210 includes hardware, software, or both providing one or more interfaces for communication (such as, for example, packet-based communication) between computer system 200 and one or more other computer systems 200 or one or more networks.

In some implementations, as an example and not by way of limitation, communication interface 210 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 210 for it.

In some implementations, as an example and not by way of limitation, computer system 200 may communicate with an ad hoc network, a personal area network (PAN), a local area network (LAN), a wide area network (WAN), a metropolitan area network (MAN), or one or more portions of the Internet or a combination of two or more of these.

In some implementations, one or more portions of one or more of these networks may be wired or wireless. In some implementations, as an example, computer system 200 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these.

In some implementations, computer system 200 may include any suitable communication interface 210 for any of these networks, where appropriate. In some implementations, communication interface 210 may include one or more communication interfaces 210, where appropriate. Although this disclosure describes and illustrates a particular communication interface, this disclosure contemplates any suitable communication interface.

In some implementations, bus 212 includes hardware, software, or both coupling components of computer system 200 to each other. In some implementations, as an example and not by way of limitation, bus 212 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCI-X) bus, a serial advanced technology attachment (SATA) bus, a Video Electronics Standards Association local (VLB) bus, or another suitable bus or a combination of two or more of these.

In some implementations, bus 212 may include one or more buses 212, where appropriate. Although this disclosure describes and illustrates a particular bus, this disclosure contemplates any suitable bus or interconnect.

Herein, reference to a computer-readable storage medium encompasses one or more non-transitory, tangible computer-readable storage media possessing structure. In some implementations, as an example and not by way of limitation, a computer-readable storage medium may include a semiconductor-based or other integrated circuit (IC) (such, as for example, a field-programmable gate array (FPGA) or an application-specific IC (ASIC)), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate.

Herein, reference to a computer-readable storage medium excludes any medium that is not eligible for patent protection under 35 U.S.C. § 101. Herein, reference to a computer-readable storage medium excludes transitory forms of signal transmission (such as a propagating electrical or electromagnetic signal per se) to the extent that they are not eligible for patent protection under 35 U.S.C. § 101.

This disclosure contemplates one or more computer-readable storage media implementing any suitable storage. In some implementations, a computer-readable storage medium implements one or more portions of processor 202 (such as, for example, one or more internal registers or caches), one or more portions of memory 204, one or more portions of storage 206, or a combination of these, where appropriate.

In some implementations, a computer-readable storage medium implements RAM or ROM. In some implementations, a computer-readable storage medium implements volatile or persistent memory.

In some implementations, one or more computer-readable storage media embody software. Herein, reference to software may encompass one or more applications, bytecode, one or more computer programs, one or more executables, one or more instructions, logic, machine code, one or more scripts, or source code, and vice versa, where appropriate.

In some implementations, software includes one or more application programming interfaces (APIs). This disclosure contemplates any suitable software written or otherwise expressed in any suitable programming language or combination of programming languages.

In some implementations, software is expressed as source code or object code. In some implementations, software is expressed in a higher-level programming language, such as, for example, C, Perl, or a suitable extension thereof. In some implementations, software is expressed in a lower-level programming language, such as assembly language (or machine code).

In some implementations, software is expressed in JAVA. In some implementations, software is expressed in Hyper Text Markup Language (HTML), Extensible Markup Language (XML), or other suitable markup language.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure. For example, it will be apparent to one of ordinary skill in the art that the invention may be used with any electronic network service, even if it is not provided through a website.

Any computer-based system that provides networking functionality can be used in accordance with the present invention even if it relies, for example, on e-mail, instant messaging or other forms of peer-to-peer communications, and any other technique for communicating between users. The invention is thus not limited to any particular type of communication system, network, protocol, format or application.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium or any type of media suitable for storing electronic instructions, and coupled to a computer system bus. Furthermore, any computing systems referred to in the specification may include a single processor or may be architectures employing multiple processor designs for increased computing capability.

While the foregoing processes and mechanisms can be implemented by a wide variety of physical systems and in a wide variety of network and computing environments, the server or computing systems described below provide example computing system architectures for didactic, rather than limiting, purposes.

The present invention has been explained with reference to specific embodiments. For example, while embodiments of the present invention have been described as operating in connection with a network system, the present invention can be used in connection with any communications facility that allows for communication of messages between users, such as an email hosting site. Other embodiments will be evident to those of ordinary skill in the art. It is therefore not intended that the present invention be limited, except as indicated by the appended claims.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

The present disclosure encompasses all changes, substitutions, variations, alterations, and modifications to the example embodiments herein that a person having ordinary skill in the art would comprehend.

The figures, including photographs and drawings, comprised herewith may represent one or more implementations of the trucking software.

Details shown in the figures, such as dimensions, descriptions, etc., are exemplary, and there may be implementations of other suitable details according to the present disclosure.

Reference throughout this specification to “an embodiment” or “implementation” or words of similar import means that a particular described feature, structure, or characteristic is comprised in at least one embodiment of the present invention. Thus, the phrase “in some implementations” or a phrase of similar import in various places throughout this specification does not necessarily refer to the same embodiment.

Many modifications and other embodiments of the inventions set forth herein will come to mind to one skilled in the art to which these inventions pertain having the benefit of the teachings presented in the foregoing descriptions and the associated drawings.

The described features, structures, or characteristics may be combined in any suitable manner in one or more embodiments. In the above description, numerous specific details are provided for a thorough understanding of embodiments of the invention. One skilled in the relevant art will recognize, however, that embodiments of the invention can be practiced without one or more of the specific details, or with other methods, components, materials, etc. In other instances, well-known structures, materials, or operations may not be shown or described in detail.

While operations may be depicted in the drawings in a particular order, this should not be understood as requiring that such operations be performed in the particular order shown or in sequential order, or that all illustrated operations be performed, to achieve desirable results.

1. A computer implemented method for connecting unaffiliated trucking related services providers, the method comprising:
storing a plurality of profiles of service providers wherein at least a portion of the service providers are unaffiliated and provide different services wherein at least one service provider offers at least one truck and truck driving services, at least one service provider offers only truck driving services, at least one service provider offers mechanic services, at least one service provider offers parking or storage services, at least one service provider offers legal services, and at least one service provider offers accounting services; and
indicating on a map the location of at least one service provider and displaying the related profile when an indicia on the map of the location is selected.

2. A computer implemented method for aggregating transactions between trucking related service providers, the method comprising:
posting by a plurality of unaffiliated users one or more trucking related job opportunities each;
distributing the trucking related job opportunities to unaffiliated truck related service providers; and
accepting at least one of the truck related job opportunities by at least one of the unaffiliated truck related service providers.

3. The computer implemented method of claim 2, the method further providing:
searching by at least one of the unaffiliated users for at least one of the unaffiliated truck related service providers.

4. The computer implemented method of claim 2, the method further providing:
displaying on a map one or more locations associated with at least one of the truck related job opportunities.

5. The computer implemented method of claim 2, the method further providing:
searching by at least one of the unaffiliated truck related service providers for at least one of the truck related job opportunities.

6. The computer implemented method of claim 2, the method further providing:
indicating on a map the location of at least one of the unaffiliated truck related service providers and displaying a related profile when an indicia on the map of the location is selected.

7. A computer implemented method for aggregating transactions between trucking related service providers, the method comprising:
storing a plurality of profiles of truck related service providers wherein at least a portion of the service providers are unaffiliated and provide different services wherein at least one service provider offers at least one truck and truck driving services, at least one service provider offers only truck driving services, at least one service provider offers mechanic services, at least one service provider offers parking or storage services, at least one service provider offers legal services, and at least one service provider offers accounting services;
posting by a plurality of unaffiliated users one or more trucking related job opportunities;
indicating on a map the location of at least one service provider and displaying the related profile when an indicia on the map of the location is selected;
distributing the trucking related job opportunities to the unaffiliated truck related service providers;
accepting at least one of the truck related job opportunities by at least one of the unaffiliated truck related service providers;
searching by at least one of the unaffiliated users for at least one of the unaffiliated truck related service providers;
displaying on a map one or more locations associated with at least one of the truck related job opportunities;
searching by at least one of the unaffiliated truck related service providers for at least one of the truck related job opportunities; and
indicating on a map the location of at least one of the unaffiliated truck related service providers and displaying a related profile when an indicia on the map of the location is selected.
